(19) United States
(12) Patent Application Publication
(10) Pub. No.: US 2025/0285776 A1
(43) Pub. Date: Sep. 11, 2025

(54) ENERGY SOURCE

(71) Applicant: WITKOWITZ ATOMICA A.S., Nove Mesto (CZ)

(72) Inventors: Frantisek CERMAK, Praha (CZ); Bronislav KULIKOV, Zlata (CZ); Martin GROCH, Praha (CZ); David CHROBOK, Hradec Kralov (CZ); Martin ULCAK, Praha (CZ)

(73) Assignee: WITKOWITZ ATOMICA A.S., Nove Mesto (CZ)

(21) Appl. No.: 19/216,047

(22) Filed: May 22, 2025

Related U.S. Application Data
(63) Continuation of application No. 17/923,036, filed on Nov. 3, 2022, now abandoned.

(30) Foreign Application Priority Data
May 7, 2020 (CZ) 2020-253

(51) Int. Cl. G21D 5/02; G21C 9/033; G21C 13/10; G21C 15/28; G21C 17/112; G21D 3/00

(52) U.S. Cl. CPC G21D 5/02; G21C 9/033; G21C 13/10; G21C 15/28; G21C 17/112; G21D 3/001

(57) ABSTRACT

An energy source using low-enriched nuclear fuel to produce heat contains a compact transportable pressure vessel containing a cylinder with the core with heating element formed by nuclear fuel and continually agitated by a directed flow of heat-exchange liquid, to which a second pressure vessel is connected with a closed water bath circuit and a heat exchanger for production of steam, while the compact transportable pressure vessel can be placed in a space selected from the group underground concrete space with stainless steel lining, sea-river vessel and container modification for road and/or railway transport.

### BACKGROUND AND SUMMARY

The present application is a continuation of U.S. application Ser. No. 17/923,036, filed Nov. 3, 2022, which is the U.S. national stage of PCT/CZ2021/050048, filed May 7, 2021, which claims priority to CZ 2020-253, filed May 7, 2020, all of which are incorporated by reference.

The invention relates to an energy source using low-enriched nuclear fuel for the production of heat, with an expected production in the power range of 2 to 100 MW.

In the technical practice, various designs of nuclear reactors are known, which are of the pressurized water type, but usually do not have forced cooling of the core and the refueling is done in the standard way as in large reactors.

No solution has been found that would allow extensive unification of power series.

The above shortcomings are, to a large extent, eliminated by the energy source using low-enriched nuclear fuel for the production of heat according to an aspect of this invention. Its principle is that it consists of or comprises a compact transportable pressure vessel, which contains a core with nuclear fuel, while the refueling can be performed only at a dedicated workplace. In the overall concept of the energy source (EZ), this part practically forms a heating element (TT) with a continuously agitated heat-exchange liquid, which may be in the form of boric acid. The internal flow of the liquid is directed and thus ensures the cooling of the cylinder, which at the same time serves as a shield against free neutrons and prevents accelerated degradation of the material of the pressure vessel.

From the above body, the heat created by the nuclear core fission process is transferred through the steel wall to the other pressure vessel with a closed water bath circuit, where the water heated by the described process if forced into the heat exchanger, where the heat transferred in this way is used in the standard way to produce steam that is used for production of electric power or utility heat in the standard way. This heating method ensures double separation of radioactive fuel from the utility steam.

The design of the core is entirely within the competence of the exclusive fuel supplier. The safety of operation of the device is further ensured by its construction placement in a space selected from the group underground concrete space with stainless steel lining, sea-river vessel and container modification for road and/or railway transport.

The concept of the layout of the main parts of the EZ allows safe handling for TT replacement and further transport in a manner already known and technically processed worldwide. The measurement of the core temperature is another information parameter for the application software ensuring safe operation for the entire period of the anticipated replacement of the TT.

The structural arrangement of the core for the given contracted power is entirely within the competence of the fuel supplier.

The conceptual design uses materials and core cooling using a long-time proven way.

This present solution provides manufacturing unification in the power series of the source or in the end use.

### BRIEF DESCRIPTION OF DRAWINGS

The energy source according to this technical solution will be further described on specific examples using the attached drawings, where

FIG. 1 shows its schematic outline, and

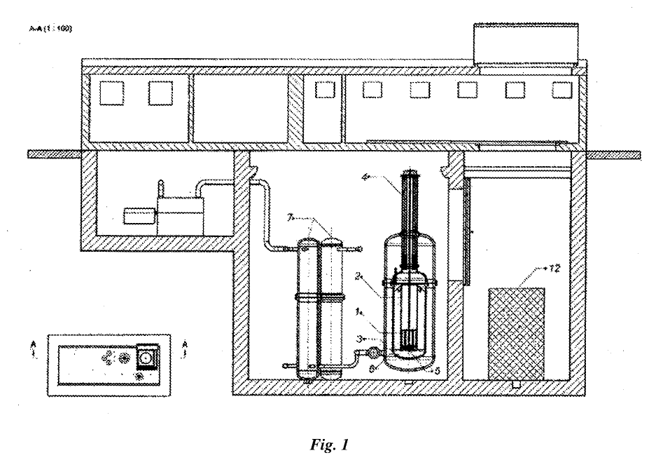

FIG. 2 its ground plan.

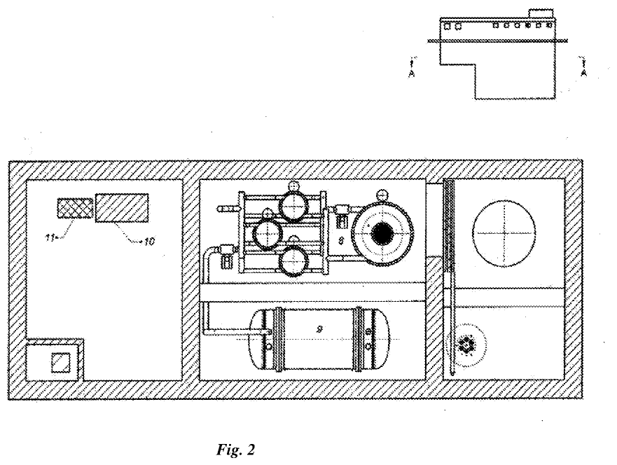

### DETAILED DESCRIPTION

An example energy source using low-enriched nuclear fuel as a heat source consists of or comprises a compact transportable pressure vessel 3, which contains a core 1 with nuclear fuel 4, while the refueling can be performed only at a dedicated workplace. In the overall concept of the energy source (EZ), this part practically forms a heating element 5 (TT) with a continuously agitated heat exchange liquid, which may be in the form of boric acid. The internal flow of the liquid is directed and thus ensures the cooling of the cylinder 2, which at the same time serves as a shield against free neutrons and prevents accelerated degradation of the material of the pressure vessel 3. Compact transportable pressure vessel 3 can be placed in a space selected from the group underground concrete space with stainless steel lining, sea-river vessel and container modification for road and/or railway transport. The bottom 6 of the pressure vessel 3 is filled with lead as a protective element for an unforeseen accident.

From the above pressure vessel 3, the heat created by the nuclear core fission process is transferred through the steel wall to the other pressure vessel with a closed water bath circuit, where the water heated by the described process if forced by pump 8 into the heat exchanger 7, where the transferred heat is used in the standard way to produce steam for production of electric power in the turbine 10 with a three-phase generator 11, or for production of utility heat in the standard way with condenser 9. This heating method ensures double separation of radioactive fuel from the utility steam.

The energy source is equipped with a temperature meter in the core with diamond-based sensors.

The energy source is equipped with another information parameter for application software ensuring safe operation for the entire period of the anticipated replacement of the heating element 5.

The heating element 5 is transported to the core 1 dismantling place in a transport container 12.

All parts are from the same steels that are used for nuclear devices of type VVER 440MW and VVER 1000MW

The energy source according to this technical solution will find application primarily as a backup power source in municipal energy industry, in the production of electricity and heat, as a stable ecological source of heat and energy.

The invention claimed is:

1. An energy source using low-enriched nuclear fuel to produce heat, comprising a compact transportable pressure vessel containing a cylinder with the core with heating element formed by nuclear fuel and continually agitated by a directed flow of heat-exchange fluid, to which a second pressure vessel is connected with a closed water bath circuit and a heat exchanger for production of steam, wherein after the heat exchanger there is condenser and/or turbine with three-phase generator, while the compact transportable pressure vessel can be placed in a container modification for road and/or railway transport, wherein a bottom of the pressure vessel is filled with lead as a protective element for an unforeseen accident, wherein the energy source is equipped with a double protection of the utility steam against any radiation contamination.

2. The energy source according to claim 1, wherein the heat-exchange fluid contains boric acid.

3. The energy source according to claim 1, wherein the energy source is equipped with a temperature meter in the core with diamond-based sensors.

4. The energy source according to claim 1, wherein the energy source is equipped with another information parameter for application software ensuring safe operation for the entire period of the anticipated replacement of the heating element.
